(19) United States
(12) Patent Application Publication
(10) Pub. No.: US 2025/0210288 A1
(43) Pub. Date: Jun. 26, 2025

(54) SPARKLESS FUSE

(71) Applicant: Hubbell Incorporated, Shelton, CT (US)

(72) Inventors: David Adelbert Rhein, Birmingham, AL (US); Cong Thanh Dinh, Birmingham, AL (US); Jacob Worthington Stacks Blake, Birmingham, AL (US)

(21) Appl. No.: 18/987,904

(22) Filed: Dec. 19, 2024

Related U.S. Application Data
(60) Provisional application No. 63/613,875, filed on Dec. 22, 2023.

(51) Int. Cl. H01H 33/666; H01H 33/662

(52) U.S. Cl. CPC H01H 33/666; H01H 33/66207; H01H 2033/6623

(57) ABSTRACT

A vacuum interrupter including a vacuum bottle having a first contact and a second contact, the second contact movable between a closed position and an open position. The vacuum interrupter also includes a harvester circuit connected to a power supply, the harvester circuit powers the vacuum interrupter via the power supply, a current sensor that senses a current of the power supply, an energy converter that moves the second contact to the open position, and an electronic controller electrically connected to the harvester circuit, the current sensor, and the energy converter. The electronic controller receives a signal indicative of the current of the power supply from the current sensor, determines the current of the power supply based on the signal, determines whether a fault is occurring on the power supply, energizes the energy converter in response to determining the fault, and opens the vacuum interrupter by energizing the energy converter.

### RELATED APPLICATIONS

This application claims the benefit of U.S. Provisional Patent Application No. 63/613,875, filed Dec. 22, 2023, the entire content of which is hereby incorporated by reference.

### FIELD

The present disclosure relates generally to circuit interrupting devices.

### SUMMARY

Electrical power distribution networks deliver power to various distribution transformers, which step down the power from a medium voltage level to a lower voltage that is provided to loads such as homes, businesses, etc. Such power distribution networks include various circuit interrupting devices, such as breakers, reclosers, and/or other switching devices, that control the flow of power throughout the network. As an example, a network circuit interrupting device, such as a recloser, may include and/or be implemented as a vacuum interrupter (e.g., a sparkless fuse) that includes opposing contacts moveable between an open position and a closed position.

When an electrical fault occurs on the power distribution network, known circuit interrupting devices often use an electrical cutout with a fuse link to interrupt the distribution of power through the power distribution network. For example, when the electrical fault occurs, the fuse link melts such that the electrical cutout drops open to form a visible break from the power distribution network. The visible break signifies to a utility company which electrical cutouts are open and where the electrical fault occurred on the power distribution network. In other examples, known circuit interrupting devices include a current limiting fuse to interrupt the distribution of power. When an electrical fault occurs, the current limiting fuse reduces current flowing through the faulted portion of the power distribution network. However, such existing solutions require that a portion, or all of the circuit interrupting device, be replaced following the electrical fault. As a result, existing circuit interrupting devices incur a greater cost to own and may result in difficulties restoring power when replacing components of the circuit interrupting device.

One aspect of the present disclosure provides a vacuum interrupter including a vacuum bottle having a first contact and a second contact. The second contact is movable relative to the first contact between a closed position and an open position. The vacuum interrupter also includes a harvester circuit electrically connected to a power supply. The harvester circuit powers the vacuum interrupter via the power supply. The vacuum interrupter also includes a current sensor that senses a current of the power supply, an energy converter that moves the second contact to the open position, and an electronic controller electrically connected to the harvester circuit, the current sensor, and the energy converter. The electronic controller receives a signal indicative of the current of the power supply from the current sensor, determines the current of the power supply based on the signal, and determines whether a fault is occurring on the power supply. The electronic controller also energizes the energy converter in response to determining the fault and opens the vacuum interrupter by energizing the energy converter.

Another aspect of the present disclosure provides a method of operating a vacuum interrupter including a vacuum bottle enclosing a first contact and a second contact. The method includes receiving, via an electronic controller, a signal indicative of a current of a power supply from a current sensor, determining, via the electronic controller, the current of the power supply based on the signal, and determining, via the electronic controller, whether a fault is occurring on the power supply. The method also includes energizing, via the electronic controller, an energy converter in response to determining the fault and opening the vacuum interrupter by energizing the energy converter.

Another aspect of the present disclosure provides a vacuum interrupter system including a mounting portion, a terminal positioned on the mounting portion and electrically connecting the vacuum interrupter system to a power supply included in a power distribution network, and a vacuum interrupter coupled to the mounting portion and selectively coupled to the power supply via the terminal. The vacuum interrupter includes a vacuum bottle having a first contact and a second contact. The second contact is movable relative to the first contact between a closed position and an open position. The vacuum interrupter also includes a harvester circuit electrically connected to the power supply. The harvester circuit powers the vacuum interrupter via the power supply. The vacuum interrupter also includes a current sensor that senses a current of the power supply, an energy converter that moves the second contact to the open position, and an electronic controller electrically connected to the harvester circuit, the current sensor, and the energy converter. The electronic controller receives a signal indicative of the current of the power supply from the current sensor, determines the current of the power supply based on the signal, and determines whether a fault is occurring on the power supply. The electronic controller also energizes the energy converter in response to determining the fault and opens the vacuum interrupter by energizing the energy converter.

Other aspects of the disclosure will become apparent by consideration of the detailed description and accompanying drawings.

### BRIEF DESCRIPTION OF THE DRAWINGS

FIG. 1 illustrates a perspective view of a vacuum interrupter system including a vacuum interrupter, according to some embodiments.

FIG. 2 illustrates a cross-sectional view of a vacuum interrupter, according to some embodiments.

FIG. 3 illustrates a block diagram of a control system of the vacuum interrupter system of FIG. 1, according to some embodiments.

FIG. 4 illustrates a schematic of a harvesting circuit included in the vacuum interrupter of FIG. 1, according to some embodiments.

FIG. 5 illustrates a cross-sectional view of a vacuum interrupter, according to some embodiments.

FIG. 6 illustrates a zoomed-in view of the vacuum interrupter of FIG. 5 in a closed position, according to some embodiments.

FIG. 7 illustrates a zoomed-in view of the vacuum interrupter of FIG. 5 in an open position, according to some embodiments.

FIG. 8 illustrates a perspective view of the vacuum interrupter system including the vacuum interrupter of FIG. 1 in an open position, according to some embodiments.

FIG. 9 is a flowchart illustrating a method of operating a vacuum interrupter, according to some embodiments.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments and of being practiced or of being carried out in various ways.

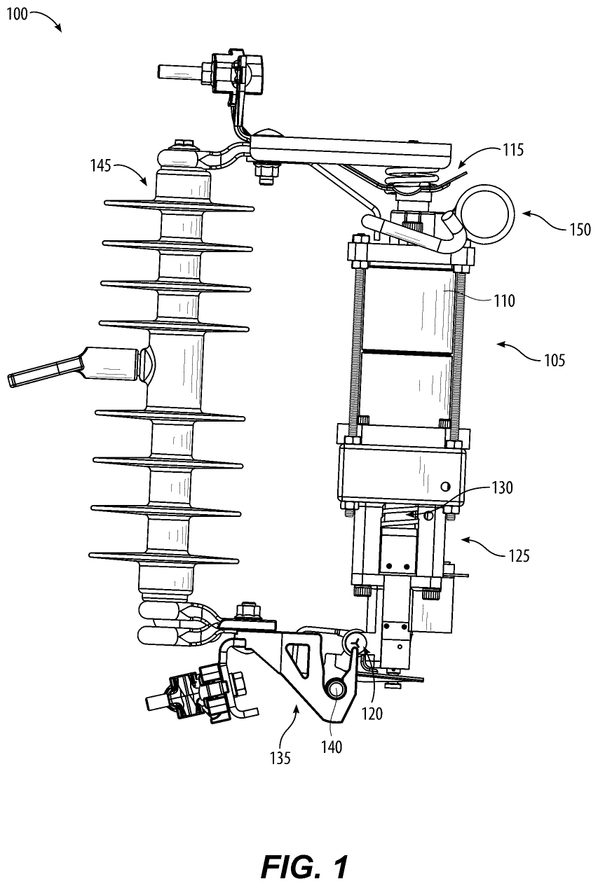

FIG. 1 illustrates a perspective view of a vacuum interrupter system 100 including a vacuum interrupter 105, according to some embodiments. The vacuum interrupter system 100 may be implemented as a circuit interrupting device included in a power distribution network, according to some embodiments. For example, the vacuum interrupter system 100 may be implemented as a recloser. In other examples, it should be understood that certain aspects of the vacuum interrupter system 100 may also be incorporated in other types of circuit interrupting devices that do not reclose, such as but not limited to non-reclosing circuit breakers and other types of switching devices included in a power distribution network.

The vacuum interrupter 105 includes a vacuum bottle (e.g., a housing) 110 that contains and/or supports one or more components for electrically connecting and disconnecting the vacuum interrupter system 100 to and from a power distribution network. In the illustrated example, the vacuum bottle 110 includes an upper housing portion that contains, for example, contacts of the vacuum interrupter 105 and a lower housing portion that contains, or otherwise supports, control electronics, an actuator, and/or various other electrical and mechanical components included in the vacuum interrupter 105. The vacuum interrupter 105 further includes first and second terminals 115, 120 that electrically connect the vacuum interrupter 105 to a power line (e.g., a power supply) included in the power distribution network. For example, the vacuum interrupter 105 is selectively coupled to the power line via the first and second terminals 115, 120. When the vacuum interrupter 105 opens, the vacuum interrupter 105 disconnects from the power line at the first terminal 115. In the illustrated example, the first, or upper, terminal 115 extends outward from a top surface of the vacuum bottle 110 and the second, or lower, terminal 120 extends outward from a side surface of the lower housing of the vacuum interrupter 105.

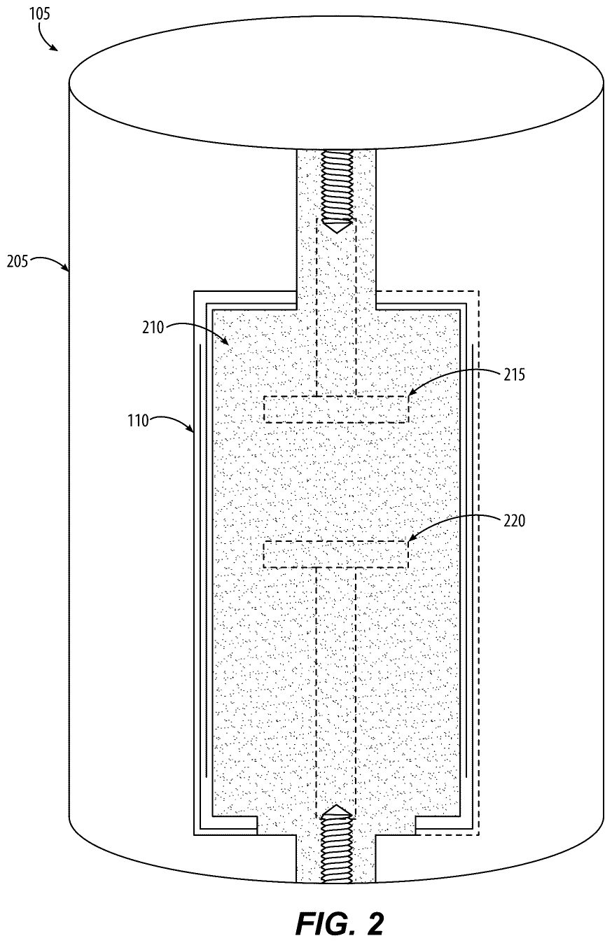

In some embodiments, vacuum interrupter 105 includes an energy converter 125 and a spring mechanism 130. In the illustrated example, the energy converter 125 is a solenoid. Although the energy converter 125 is described herein as being implemented as a solenoid, it should be understood that the energy converter 125 may also be implemented as a relay, a contactor, and/or other electro-mechanical energy conversion devices. In some embodiments, the lower portion of the vacuum bottle 110 is coupled to the energy converter 125 and the spring mechanism 130. As described below with respect to FIGS. 2 and 5-9, the energy converter 125 is configured to open the vacuum interrupter 105 by moving the spring mechanism 130 from a compressed position to an expanded position. In the illustrated example of FIG. 1, the spring mechanism 130 is in the compressed position such that vacuum interrupter 105 is electrically connected to the power line via the first terminal 115.

In some embodiments, the vacuum interrupter 105 also includes a hinge 135 coupled to the spring mechanism 130 and the vacuum interrupter 105. In some embodiments, the hinge 135 further includes a trunnion 140. The hinge 135 is configured to move relative to the spring mechanism 130 between a closed hinge position and an open hinge position via the trunnion 140. In the illustrated example of FIG. 1, the hinge 135 is in the closed hinge position. As described below with respect to FIGS. 2 and 5-9, when the energy converter 125 opens the vacuum interrupter 105, the trunnion 140 is configured to rotate such that the hinge 135 moves to the open hinge position and the vacuum interrupter 105 disconnects from the power line at the first terminal 115. In some embodiments, the hinge 135 also couples the vacuum interrupter 105 to a mounting portion 145. The mounting portion 145 may be a standard electrical cutout affixed to a distribution pole of the power distribution network. The mounting portion 145 may be configured to support the vacuum interrupter 105 in close proximity to the power line. In some embodiments, the first terminal 115 may be positioned on the mounting portion 145 to electrically connect the vacuum interrupter system 100 to the power line. In some embodiments, the vacuum interrupter 105 further includes a pull ring 150. In some embodiments, the pull ring 150 may extend from the upper housing of the vacuum bottle 110. When the vacuum interrupter 105 is open, the vacuum interrupter 105 may be reset via the pull ring 150.

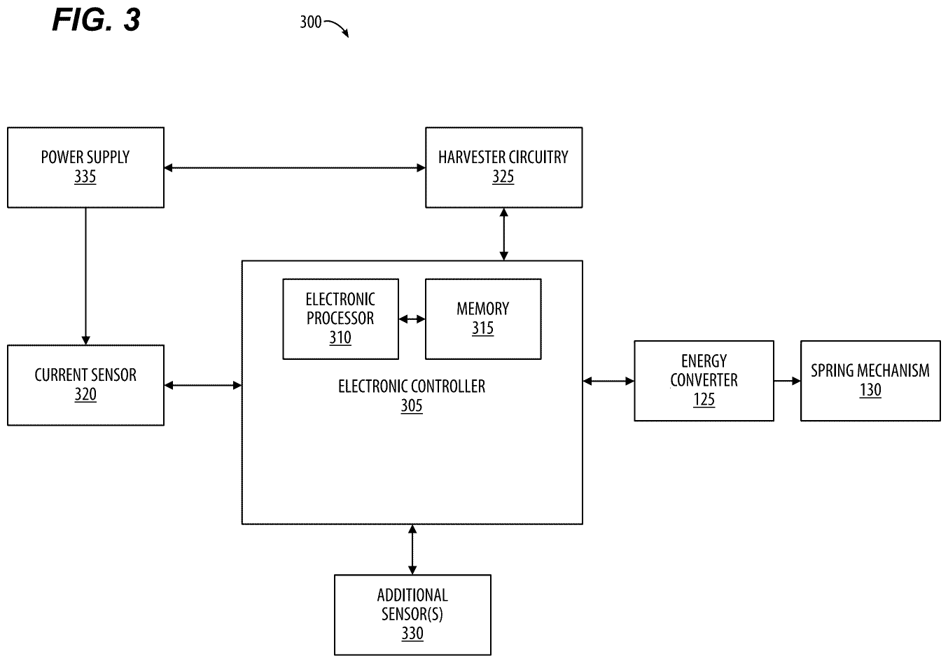

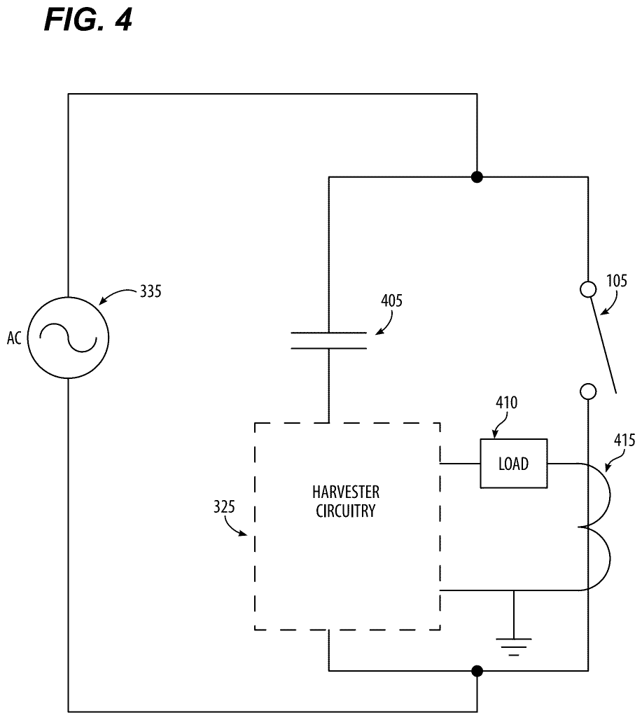

FIG. 2 illustrates a cross-sectional view of a portion of the vacuum interrupter 105, according to some embodiments. In some embodiments, the vacuum interrupter 105 includes an insulating housing 205 that encloses, or contains, the vacuum bottle 110. The insulating housing 205 is formed of, for example, one or more insulating materials. The vacuum bottle 110 defines a vacuum chamber 210 that encloses a fixed contact (e.g., a first contact) 215 and a moveable contact (e.g., a second contact) 220. The first contact 215 is electrically connected to the first terminal 115 of the vacuum interrupter 105 and the second contact 220 is electrically connected to the second terminal 120 of the vacuum interrupter 105. When the first and second contacts 215, 220 are in contact with each other (e.g., the vacuum interrupter 105 is closed), the second contact 220 is in a closed position and current flows from the power line of the power distribution network through the first and second contacts 215, 220 of the vacuum interrupter 105. The current that flows through vacuum interrupter 105 while the first and second contacts 215, 220 are in contact with each other is converted and used to power a load, such as one or more electronics included in the vacuum interrupter 105. For example, one or more of a controller, control circuits, sensors, an actuator, communication devices, and/or other circuit components are powered with the converted line current that flows through the vacuum interrupter 105, for example, via power harvesting circuitry (shown in FIGS. 3 and 4).

When the first and second contacts 215, 220 are separated to open the vacuum interrupter 105 (as shown in FIG. 2), the second contact 220 is in an open position and current does not flow through the first and second contacts 215, 220 of the vacuum interrupter 105. Thus, there is no current flowing through the vacuum interrupter 105 that can be used to power the electronics included in the vacuum interrupter 105 when the vacuum interrupter 105 is open. In some embodiments, a capacitor is electrically connected in parallel with the vacuum interrupter 105 to harvest energy from the power distribution network when the vacuum interrupter 105 is open.

FIG. 3 illustrates a block diagram of a control system 300 of the vacuum interrupter system 100 of FIG. 1, according to some embodiments. In some embodiments, some or all of the components of the control system 300 may be implemented in the vacuum interrupter 105. In other embodiments, some components of the control system 300 may be implemented external to the vacuum interrupter 105. In some embodiments, the control system 300 includes an electronic controller 305. For example, the vacuum interrupter 105 includes the electronic controller 305. The electronic controller 305 may be an integrated circuit device, such as a Microchip microcontroller. However, in other embodiments, the electronic controller 305 is implemented as another type of processor-based control device. The electronic controller 305, which includes an electronic processor 310 and a memory 315, may be configured to control various operations of the vacuum interrupter 105. For example, in some embodiments, the electronic controller 305 is configured to detect the occurrence of an electrical fault.

As illustrated in FIG. 3, the electronic controller 305 is electrically and/or communicatively connected to a variety of modules or components of the vacuum interrupter 105. For example, the electronic controller 305 is electrically connected to a current sensor 320, a harvester circuit (e.g., harvester circuitry) 325, the energy converter 125, and additional sensor(s) 330.

In some embodiments, the electronic controller 305 includes a plurality of electrical and electronic components that provide power, operational control, and protection to the components and modules within the electronic controller 305 and/or the vacuum interrupter 105. For example, the electronic controller 305 includes, among other things, the electronic processor 310 (for example, a microprocessor or another suitable programmable device) and the memory 315.

The memory 315 includes, for example, a program storage area and a data storage area. The program storage area and the data storage area can include combinations of different types of memory, such as read-only memory (ROM) and/or random-access memory (RAM). Various non-transitory computer readable media, for example, magnetic, optical, physical, or electronic memory may be used. The electronic processor 310 is communicatively coupled to the memory 315 and executes software instructions that are stored in the memory 315, or stored on another non-transitory computer readable medium such as another memory or a disc. Instructions may include instructions, which when executed by the electronic processor 310, cause the control system 300 to implement any of a variety of electrical fault detection actions as described herein. The software may include one or more applications, program data, filters, rules, one or more program modules, and other executable instructions.

In some embodiments, the current sensor 320 is electrically connected to a power supply (e.g., the power line of the power distribution network) 335. The current sensor 320 may be configured to sense a current of the power supply 335 and transmit a signal indicative of the current of the power supply 335 to the electronic controller 305. For example, the current sensor 320 may be a Rogowski Coil, a current transformer, a magnetic field current sensor, a fiber optic current sensor, or any other suitable current sensor for use in power distribution networks. In some embodiments, the harvester circuit 325 is also electrically connected to the power supply 335. The harvester circuit 325 may be configured to provide power the electronic controller 305 and components of the vacuum interrupter 105 via the power supply 335 (as shown in FIG. 4). In some embodiments, the additional sensor(s) 330 may include a temperature sensor, a voltage sensor, a humidity sensor, a capacitive sensor, a magnetic sensor, or any other suitable sensor for sensing characteristics of power distribution networks.

In some embodiments, when the electronic controller 305 determines an electrical fault of the power supply 335, the electronic controller 305 is configured to energize the energy converter 125. For example, the electronic controller 305 is configured to open the vacuum interrupter 105 by providing power to the energy converter 125. In some embodiments, the energy converter 125 is coupled to the spring mechanism 130. In some embodiments, the electronic controller 305 energizes the energy converter 125 and the energy converter 125 actuates the spring mechanism 130. When actuated, the spring mechanism 130 moves from the compressed position to the expanded position. As the spring mechanism 130 moves from the compressed position to the open position, a compaction force is released between the first contact 215 and the second contact 220 such that the second contact 220 moves from the closed position to the open position relative to the first contact 215.

FIG. 4 illustrates a schematic of the harvester circuit 325 included in the vacuum interrupter 105 of FIG. 1, according to some embodiments. In some embodiments, a high voltage, high impedance capacitor 405 is electrically connected in parallel with the vacuum interrupter 105. For example, the capacitor 405 and the vacuum interrupter 105 are electrically connected in parallel between the power supply 335 included in the power distribution network and a load 410 that includes one or more of the electronics, such as a controller, sensors, an actuator, communication devices, and/or other circuit components included in the vacuum interrupter 105. When the vacuum interrupter 105 is closed (e.g., the second contact 220 is in the closed position), current flows from the power supply 335 in the distribution network and through the lower impedance vacuum interrupter 105, as the impedance of vacuum interrupter 105 is much smaller, or less, than the impedance of the high voltage, high impedance capacitor 405. Moreover, current from the power supply 335 does not flow through the capacitor 405 when the vacuum interrupter 105 is closed because the impedance of the vacuum interrupter 105 is much less than the impedance of the capacitor 405. That is, the vacuum interrupter 105 shorts the capacitor 405 when the vacuum interrupter 105 is closed. A current transformer 415 is connected in series with the vacuum interrupter 105 and provides power to the load 410 when the vacuum interrupter 105 is closed and conducting current.

When the vacuum interrupter 105 is open (e.g., the second contact 220 is in the open position), a relatively small current flows through the high voltage, high impedance capacitor 405 that is harvested for powering the load 410. For example, when the vacuum interrupter 105 is open, the capacitor 405 harvests, or conducts, AC current from the power supply 335 and the harvester circuit 325 converts the harvested AC current into direct current (DC) current for powering the electronics included in the load 410.

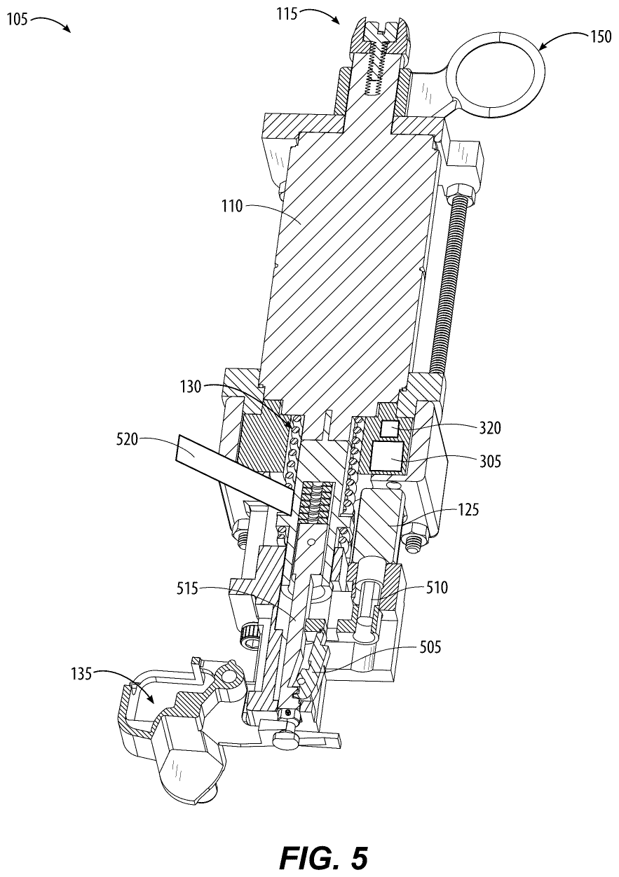

FIG. 5 illustrates a cross-sectional view of the vacuum interrupter 105, according to some embodiments. In the illustrated example of FIG. 5, the vacuum interrupter 105 is closed. For example, the second contact 220 is in the closed position and the first terminal 115 is electrically connected to the power supply 335. In some embodiments, the vacuum interrupter 105 further includes a latch 505 coupled to the energy converter 125. In some embodiments, the latch 505 is coupled to an energy converter output 510. The energy converter output 510 may be a piston, a plunger, or a rod that the energy converter 125 actuates when energized. Accordingly, in some embodiments, the latch 505 is movable relative to the energy converter 125 between a latched position and an unlatched position. For example, when the electronic controller 305 energizes the energy converter 125, the energy converter 125 actuates the energy converter output 510 to move the latch 505 from the latched position to the unlatched position. In the illustrated example of FIG. 5, the latch 505 is shown in the latched position while the vacuum interrupter 105 is closed.

In some embodiments, the latch 505 is also coupled to the spring mechanism 130 via a spring mechanism detent 515. When the latch 505 is in the latched position, the latch 505 is in contact with the spring mechanism detent 515 and holds the spring mechanism 130 in the compressed position. As the latch 505 moves from the latched position to the unlatched position, the latch 505 releases the spring mechanism detent 515 such that the spring mechanism 130 moves from the compressed position to the expanded position. In some embodiments, the spring mechanism 130 is also coupled to the hinge 135 via the spring mechanism detent 515. As the spring mechanism 130 moves from the compressed position to the expanded position, the spring mechanism 130 moves the hinge 135 from the closed hinge position to the open hinge position via the spring mechanism detent 515. In the illustrated embodiment of FIG. 5, the spring mechanism 130 is shown in the compressed position and the hinge 135 is shown in the closed hinge position.

In some embodiments, the vacuum interrupter 105 includes a load break device 520. In some embodiments, the load break device 520 may be a lever. The load break device 520 may be manually pulled to break a load of the vacuum interrupter 105 while the vacuum interrupter 105 receives current from the power supply 335. For example, pulling the load break device 520 releases the spring mechanism 130 to move from the compressed position to the expanded position. The spring mechanism 130 moves the hinge 135 from the closed hinge position to the open hinge position via the spring mechanism detent 515 and the vacuum interrupter 105 opens.

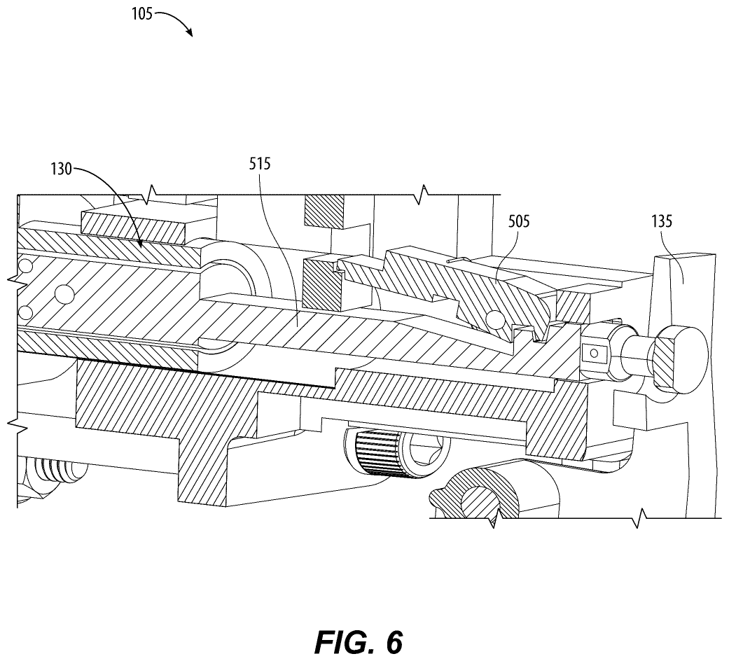

FIG. 6 illustrates a zoomed-in view of the vacuum interrupter 105 of FIG. 5 in the closed position, according to some embodiments. In such embodiments, the latch 505 is in the latched position. Accordingly, the latch 505 contacts the spring mechanism detent 515 and the latch 505 maintains the spring mechanism 130 in the compressed position via contact with the spring mechanism detent 515. Accordingly, the hinge 135 is coupled to the spring mechanism detent 515 and stays in the closed hinge position while the spring mechanism 130 is in the compressed position.

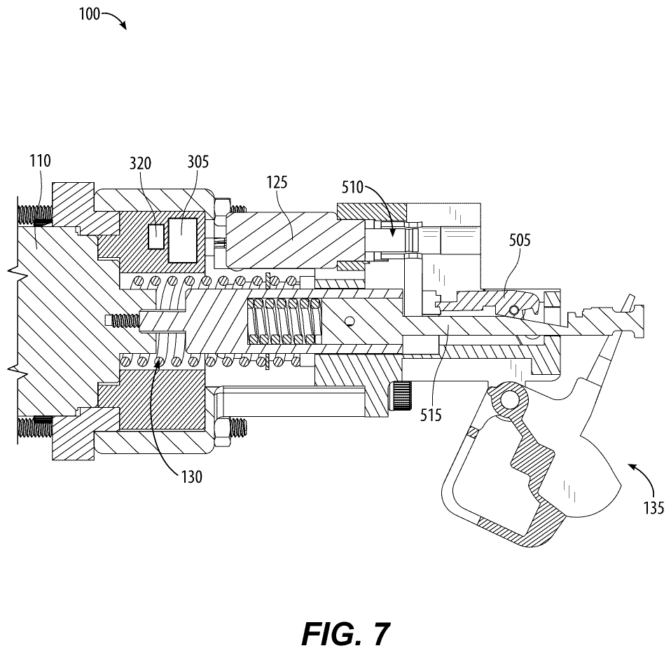

FIG. 7 illustrates a zoomed-in view of the vacuum interrupter 105 of FIG. 5 in the open position, according to some embodiments. For example, the second contact 220 is in the open position and the first terminal 115 is electrically disconnected from the power supply 335. In some embodiments, the vacuum interrupter 105 moves to the open position when the electronic controller 305 energizes the energy converter 125. Accordingly, the energy converter 125 actuates the energy converter output 510 to move the latch 505 from the latched position to the unlatched position. In some embodiments, the when the latch 505 moves to the unlatched position, the latch 505 moves the spring mechanism 130 from the compressed position to the expanded position by releasing contact between the latch 505 and the spring mechanism detent 515.

In addition, in some embodiments, as the spring mechanism 130 moves to the expanded position, the spring mechanism 130 reduces the compaction force of the vacuum interrupter 105 and moves the second contact 220 from the closed position to the open position. Thus, the second contact 220 is disconnected from the first contact 215 which disconnects the first terminal 115 from the power supply 335. As the spring mechanism 130 moves to the expanded position, the spring mechanism 130 moves the hinge 135 from the closed hinge position to the open hinge position via the spring mechanism detent 515. For example, the spring mechanism detent 515 moves the hinge 135 and changes a center of gravity of the vacuum interrupter 105. Thus, as the center of gravity of the vacuum interrupter 105 changes, the trunnion 140 rotates to move the hinge 135 to the open hinge position.

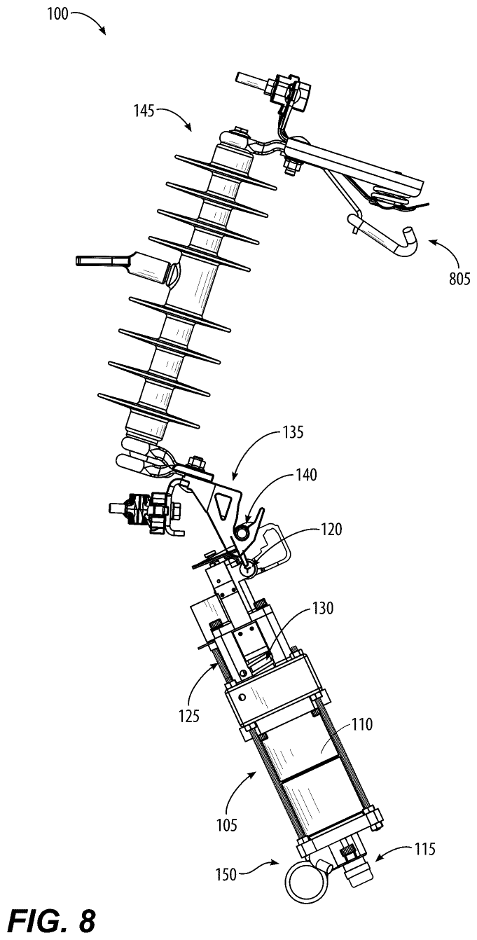

FIG. 8 illustrates a perspective view of the vacuum interrupter system 100 including the vacuum interrupter 105 of FIG. 1 in the open position, according to some embodiments. In the illustrated example of FIG. 8, the vacuum interrupter 105 visibly breaks from the power supply 335 at the first terminal 115. For example, as described above in reference to FIG. 7, the trunnion 140 rotates to move the hinge 135 to the open hinge position and the vacuum interrupter 105 drops out of the mounting portion 145. In some embodiments, the mounting portion 145 includes a retention mechanism 805 that holds the vacuum interrupter 105 relative to the mounting portion 145 at the first terminal 115. Accordingly, as the vacuum interrupter 105 drops out of the mounting portion 145, the vacuum interrupter 105 disconnects from the retention mechanism 805. In some embodiments, the vacuum interrupter system 100 can be manually reset via the pull ring 150. When the vacuum interrupter 105 is in the open position, the vacuum interrupter 105 is configured to be reset by moving the vacuum interrupter 105, via the pull ring 150, such that the first terminal 115 is in electrical contact with the power supply 335. For example, the pull ring 150 can be pushed with a hotstick to close the vacuum interrupter system 100 by moving the first terminal 115 into electrical contact with the power supply 335 via the mounting portion 145. Accordingly, by resetting the vacuum interrupter 105, the second contact 220 is moved from the open position to the closed position.

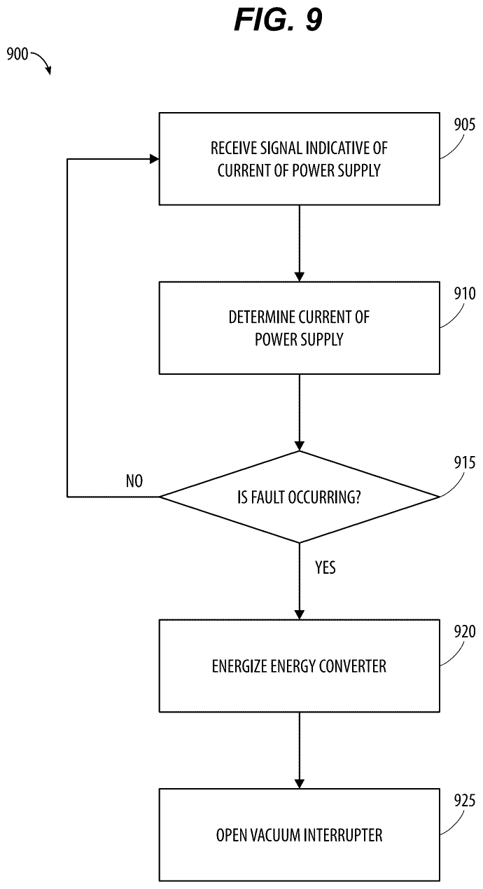

FIG. 9 is a flowchart of a method 900 of operating the vacuum interrupter 105, according to some embodiments. For example, the method 900 is implemented to detect whether an electrical fault is present on the power supply 335 to which the vacuum interrupter 105 is connected. It should be understood that the order of the steps disclosed in method 900 could vary. Although some steps are illustrated as occurring in serial order, in other embodiments, the steps disclosed may be performed in parallel order. Furthermore, additional steps may be added to the process and not all of the steps may be required.

In one embodiment, the method 900 is performed by an electronic controller, such as the electronic controller 305. However, in other embodiments, the method 900 may be performed via other components within the control system 300, such as a combination of the electronic controller 305 and the current sensor 320.

At step 905, the electronic controller 305 receives a signal indicative of a current of the power supply 335 from the current sensor 320. In some embodiments, the current sensor 320 senses the current of the power supply 335. The current sensor 320 may transmit the signal indicative of the current to the electronic controller 305.

At step 910, the electronic controller 305 determines the current of the power supply 335 based on the signal. For example, the electronic processor 310 may execute software instructions that are stored in the memory 315 to determine the current of the power supply 335 based on the signal. At step 915, the electronic controller 305 determines whether an electrical fault (e.g., a fault) is occurring on the power supply 335 based on the determined current. When the electronic controller 305 determines that the electrical fault is not occurring, the method 900 returns to step 905 and the electronic controller 305 continues to receive the signal indicative of the current of the power supply 335 via the current sensor 320.

When the electronic controller 305 determines that the electrical fault is occurring, the method 900 proceeds to step 920. At step 920, the electronic controller 305 energizes the energy converter 125 in response to determining the electrical fault.

At step 925, the electronic controller 305 opens the vacuum interrupter 105 by energizing the energy converter 125. In some embodiments, opening the vacuum interrupter 105 includes moving the second contact 220 from the closed position to the open position. Additionally, in some embodiments, the vacuum interrupter 105 visibly breaks from the power supply 335 at the first terminal 115 when the vacuum interrupter opens. For example, the electronic controller 305 energizes the energy converter 125 and the energy converter 125 actuates the energy converter output 510. In some embodiments, the energy converter 125 moves the latch 505 from the latched position to the unlatched position via the energy converter output 510. In some embodiments, the latch 505 moves the spring mechanism 130 from the compressed position to the expanded position by releasing the spring mechanism detent 515 via the latch 505 in the unlatched position. In some embodiments, the spring mechanism 130 moves the hinge 135 from the closed hinge position to the open hinge position via the spring mechanism detent 515 when the spring mechanism 130 is in the expanded position. In some embodiments, moving the hinge 135 to the open hinge position includes the trunnion 140 rotating the hinge 135 from the closed hinge position to the open hinge position. Accordingly, the vacuum interrupter 105 opens and drops out of the mounting portion 145. Additionally, by dropping the vacuum interrupter 105 out of the mounting portion 145, the vacuum interrupter 105 simultaneously clears the electrical fault from the power supply 335.

It should be understood that after the electronic controller 305 opens the vacuum interrupter 105 at step 925, the method 900 can be repeated by resetting the vacuum interrupter 105 to the closed position. For example, the method 900 returns to step 905 when the vacuum interrupter 105 is reset. In some embodiments, the vacuum interrupter 105 is reset by moving the vacuum interrupter 105, via the pull ring 150, such that the first terminal 115 is in electrical contact with the power supply 335. In some embodiments, when the vacuum interrupter 105 is reset, the vacuum interrupter 105 moves second contact 220 from the open position to the closed position. For example, by moving the vacuum interrupter 105 via the pull ring 150, the hinge 135 automatically moves from the open hinge position to the closed hinge position by rotation of the trunnion 140. By moving the hinge 135 to the closed hinge position, the hinge 135 automatically moves the spring mechanism 130 from the expanded position to the compressed position and the latch 505 automatically resets to contact the spring mechanism detent 515. Furthermore, by resetting the spring mechanism 130, the compaction force may be reset such that the second contact 220 moves to the closed position and the vacuum interrupter 105 receives current again from the power supply 335.

Thus, the disclosure provides, among other things, a system and method for operating a vacuum interrupter (e.g., a sparkless fuse). Various features and advantages of the various embodiments disclosed herein are set forth in the following claims. In the foregoing specification, specific examples, features, and aspects have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A vacuum interrupter comprising:
a vacuum bottle including a first contact and a second contact, the second contact movable relative to the first contact between a closed position and an open position,
a harvester circuit electrically connected to a power supply, the harvester circuit configured to power the vacuum interrupter via the power supply,
a current sensor configured to sense a current of the power supply,
an energy converter configured to move the second contact to the open position, and
an electronic controller electrically connected to the harvester circuit, the current sensor, and the energy converter, the electronic controller configured to:
receive a signal indicative of the current of the power supply from the current sensor,
determine the current of the power supply based on the signal,
determine whether a fault is occurring on the power supply,
energize the energy converter in response to determining the fault, and
open the vacuum interrupter by energizing the energy converter.

2. The vacuum interrupter of claim 1, wherein opening the vacuum interrupter includes moving the second contact from the closed position to the open position.

3. The vacuum interrupter of claim 1, further comprising:
a terminal configured to electrically connect the vacuum interrupter to the power supply included in a power distribution network, wherein opening the vacuum interrupter disconnects the vacuum interrupter from the power supply at the terminal.

4. The vacuum interrupter of claim 3, wherein opening the vacuum interrupter visibly breaks the vacuum interrupter from the power supply at the terminal.

5. The vacuum interrupter of claim 1, wherein after opening the vacuum interrupter, the vacuum interrupter is configured to be reset.

6. The vacuum interrupter of claim 5, wherein resetting the vacuum interrupter includes moving the vacuum interrupter such that a terminal is in electrical contact with the power supply, and
wherein resetting the vacuum interrupter moves the second contact from the open position to the closed position.

7. The vacuum interrupter of claim 1, further comprising:
a latch coupled to the energy converter, the latch movable relative to the energy converter between a latched position and an unlatched position,
a spring mechanism coupled to the latch, the spring mechanism movable relative to the latch between a compressed position and an expanded position, and
a hinge coupled to the spring mechanism and the vacuum interrupter, the hinge movable relative to the spring mechanism between a closed hinge position and an open hinge position.

8. The vacuum interrupter of claim 7, wherein the energy converter is configured to:
move the latch, via the energy converter, from the latched position to the unlatched position,
move the spring mechanism, via the latch in the unlatched position, from the compressed position to the expanded position, and
move the hinge, via the spring mechanism in the expanded position, from the closed hinge position to the open hinge position,
wherein moving the hinge from the closed hinge position to the open hinge position opens the vacuum interrupter.

9. The vacuum interrupter of claim 1, wherein the energy converter is a solenoid.

10. A method of operating a vacuum interrupter including a vacuum bottle enclosing a first contact and a second contact, the method comprising:
receiving, via an electronic controller, a signal indicative of a current of a power supply from a current sensor,
determining, via the electronic controller, the current of the power supply based on the signal,
determining, via the electronic controller, whether a fault is occurring on the power supply,
energizing, via the electronic controller, an energy converter in response to determining the fault, and
opening the vacuum interrupter by energizing the energy converter.

11. The method of claim 10, wherein opening the vacuum interrupter includes moving the second contact from a closed position to an open position.

12. The method of claim 10, wherein opening the vacuum interrupter visibly breaks the vacuum interrupter from the power supply at a terminal of the vacuum interrupter connected to the power supply.

13. The method of claim 10, further comprising:
resetting the vacuum interrupter to connect to the power supply.

14. The method of claim 13, wherein resetting the vacuum interrupter includes moving the vacuum interrupter such that a terminal is in electrical contact with the power supply, and
wherein resetting the vacuum interrupter moves the second contact from an open position to a closed position.

15. The method of claim 10, further comprising:
moving a latch coupled to the energy converter, via the energy converter, from a latched position to an unlatched position,
moving a spring mechanism coupled to the latch, via the latch in the unlatched position, from a compressed position to an expanded position, and
moving a hinge coupled to the spring mechanism and the vacuum interrupter, via the spring mechanism in the expanded position, from a closed hinge position to an open hinge position,
wherein moving the hinge from the closed hinge position to the open hinge position opens the vacuum interrupter.

16. The method of claim 10, wherein the energy converter is a solenoid.

17. A vacuum interrupter system comprising:
a mounting portion;
a terminal positioned on the mounting portion and configured to electrically connect the vacuum interrupter system to a power supply included in a power distribution network; and
a vacuum interrupter coupled to the mounting portion and selectively coupled to the power supply via the terminal, the vacuum interrupter including
a vacuum bottle having a first contact and a second contact, the second contact movable relative to the first contact between a closed position and an open position,
a harvester circuit electrically connected to the power supply, the harvester circuit configured to power the vacuum interrupter via the power supply,
a current sensor configured to sense a current of the power supply,
an energy converter configured to move the second contact to the open position, and
an electronic controller electrically connected to the harvester circuit, the current sensor, and the energy converter, the electronic controller configured to:
receive a signal indicative of the current of the power supply from the current sensor,
determine the current of the power supply based on the signal,
determine whether a fault is occurring on the power supply,
energize the energy converter in response to determining the fault, and
open the vacuum interrupter by energizing the energy converter.

18. The vacuum interrupter system of claim 17, wherein opening the vacuum interrupter includes moving the second contact from the closed position to the open position.

19. The vacuum interrupter system of claim 17, wherein opening the vacuum interrupter visibly breaks the vacuum interrupter from the power supply at the terminal.

20. The vacuum interrupter system of claim 17, wherein after opening the vacuum interrupter, the vacuum interrupter is configured to be reset.
